(19) United States
(12) Patent Application Publication
(10) Pub. No.: US 2014/0214585 A1
(43) Pub. Date: Jul. 31, 2014

(54) TELEPRESENCE ASSISTED ITEM TRANSPORT FACILITATION

(71) Applicant: MOVELINE GROUP, INC, New York, NY (US)

(72) Inventors: Frederick Cook, New York, NY (US); Kelly Eidson, New York, NY (US)

(73) Assignee: Moveline Group, Inc, New York, NY (US)

(21) Appl. No.: 13/867,869

(22) Filed: Apr. 22, 2013

Related U.S. Application Data
(63) Continuation of application No. 13/781,453, filed on Feb. 28, 2013, now abandoned.
(60) Provisional application No. 61/758,623, filed on Jan. 30, 2013.

(51) Int. Cl. G06Q 30/06

(52) U.S. Cl. CPC G06Q 30/0611
USPC 705/26.4

(57) ABSTRACT

Systems and techniques for telepresence assisted item transport facilitation are described herein. Telepresence data about a physical space can be received where the physical space includes a plurality of transport items for a client. The telepresence data can be interacted with to permit evaluation of the plurality of transport items. A normalized evaluation of the plurality of transport items can be stored based on the interaction with the telepresence data. A set of transportation quotes can be generated for members of a set of transportation vendors for the plurality of transport items. The set of transportation quotes can be presented to the client.

### CLAIM OF PRIORITY

This application is a continuation of U.S. application Ser. No. 13/781,453, filed Feb. 28, 2013, titled “TELEPRESENCE ASSISTED ITEM TRANSPORT FACILITATION,” which claims the benefit of priority under 35 U.S.C. §119(e) to U.S. Provisional Application No. 61/758,623, filed Jan. 30, 2013, titled “TELEPRESENCE ASSISTED ITEM TRANSPORT FACILITATION,” which are hereby incorporated by reference herein.

### BACKGROUND

Moving from one location to another can be a burden on private people (e.g., homeowners) and public people (e.g., businesses) alike. Often, the current space includes a number of items that will need to be packaged, moved, and then unpackaged at the destination. To ease this burden, people may employ the services of a transportation vendor (e.g., mover or moving company, relocation company, etc.).

In order to assess resource needs and pricing, the transportation vendor may collect information about transport items (e.g., items to be moved) for the client (e.g., person's or entities invoking a transportation vendor's services). In an example, the transportation vendor may ask for an evaluation (e.g., inventory) of the items from the client. The description may address the number or type of packaging materials (e.g., boxes, wrapping) needed to package the transport items. The evaluation may also address transportation requirements, such as the number or size of vehicles to transport the packaged transport items. In an example, the evaluation may take place over a telephone (e.g., telephone-based assessment).

In an example, the transportation vendor may schedule an on-site (e.g., in-home) inspection to get the evaluation. An on-site interview may include scheduling a time to meet an evaluator on the premises and permitting access to, for example, one's home to perform the evaluation.

After an evaluation is performed, the vendor may provide a transportation quote to the client. The transportation quote includes the costs of moving the transport items. After the quote is given, the client can choose to accept the quote. If the client does accept the quote, the client will work with the transportation vendor to carry out the work as well as pay the transportation vendor.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of a system for telepresence assisted item transport facilitation, according to an embodiment.

FIG. 2 illustrates an example of a method for telepresence assisted item transport facilitation, according to an embodiment.

FIG. 3 illustrates an example of a method for generating transportation quotes, according to an embodiment.

FIG. 4 illustrates an example of a method for updating the stored normalized evaluation, according to an embodiment.

FIG. 5 illustrates an example of a method for scheduling telepresence data capture, according to an embodiment.

FIG. 6 illustrates an example of a method for client quote acceptance, according to an embodiment.

FIG. 7 illustrates an example of a method for incorporating feedback of item transport, according to an embodiment.

FIG. 8 is a block diagram illustrating an example of a machine upon which one or more embodiments may be implemented.

### DETAILED DESCRIPTION

As discussed above, the two ways in which transportation vendors evaluate transport items for resource requirements and service price are self-reporting by clients and on-site evaluations. Client provided evaluations—such as those provided over the telephone—can induce inaccuracies due to client inexperience in performing accurate transport item evaluations. These inaccuracies can lead to mismatch in resource needs or pricing. In order to avoid losing money, transportation vendors may provide pricing guidelines as opposed to quotes for the service. Thus, the client may not know what price they will ultimately pay for the service.

On-site evaluations, while probably more accurate than client provided evaluations, can be difficult to schedule, intrusive, and expensive. Moreover, a cost-conscious client may wish to get quotes from multiple transportation vendors. Such activities increase the costs and inconvenience on all parties because the transportation vendors must pay for the time and expertise of an evaluator possibly without a return and the client must schedule and endure the intrusion of multiple people onto the site. In the case of a home or business, such intrusions can interrupt one's home life or interfere with business operations. Further, the transportation vendor's costs may increase by maintaining enough personnel with evaluation expertise to satisfy customer demands.

The benefits of on-site evaluations with the cost-effective convenience of client provided evaluations can be achieved with telepresence assisted item transport facilitation. Telepresence data—such as video, audio, tactile feedback, and measuring devices (e.g., scales, range-finders, etc.)—about a physical space (e.g., home, business, warehouse, room, etc.), including a plurality of transport items, can be received. The telepresence data can be interacted with to permit evaluation of the plurality of transport items. Thus, telepresence and interaction technology can provide an evaluator with sensory information similar to that which they would obtain when visiting the site without the scheduling difficulties or physical intrusion of on-site evaluations.

A normalized evaluation of the plurality of transport items can be stored based on the interaction with the telepresence data. Normalizing the evaluation can allow for a single evaluation to be used by different entities, such as a plurality of the transportation vendors. Thus, a set of transportation quotes can be generated for members of a set of transportation vendors for the plurality of transport items. This set of transportation quotes can then be presented to the client.

Accordingly, in an example, the client can receive multiple transportation quotes from multiple transportation vendors without the compounded inconvenience of providing evaluations to each. Further, transportation vendors can eschew the cost of many experienced evaluation personnel. Also, by normalizing the evaluation, the evaluation itself can be judged and adjusted to meet different transportation vendor requirements or practices. For example, in the case of relocation, the client (e.g., a business relocating an employee) may use a single transportation vendor (e.g., the cardinality of the set of transportation vendors is one). By making the normalized evaluation available to the relocation transportation vendor, that vendor can adjust any resource estimates or invoicing based the available normalized evaluation.

In an example, transportation quotes can be generated without instance (e.g., request for quote) specific participation. For example, a set of transportation vendors can provide a schedule of fees for one or more items in the normalized evaluation. In an example, generating the set of transportation quotes can include soliciting quotes from members of the set of transportation vendors. These quotes can then be included in the set of transportation quotes (e.g., alone or along with transportation quotes generated from transportation vendor supplied fee schedules). Other examples can include activities such as providing insurance to the client or transportation vendor, handling payment or disputes between the parties, soliciting from and maintaining feedback of the parties.

Further details and example components of telepresence assisted item transport facilitation are described below. By using telepresence assisted item transport facilitation, costs for both transportation vendors and for clients can be reduced. Further, each party can avoid the inconvenience of either insufficient client provided evaluations or intrusive on-site evaluations while maintaining the benefits of each.

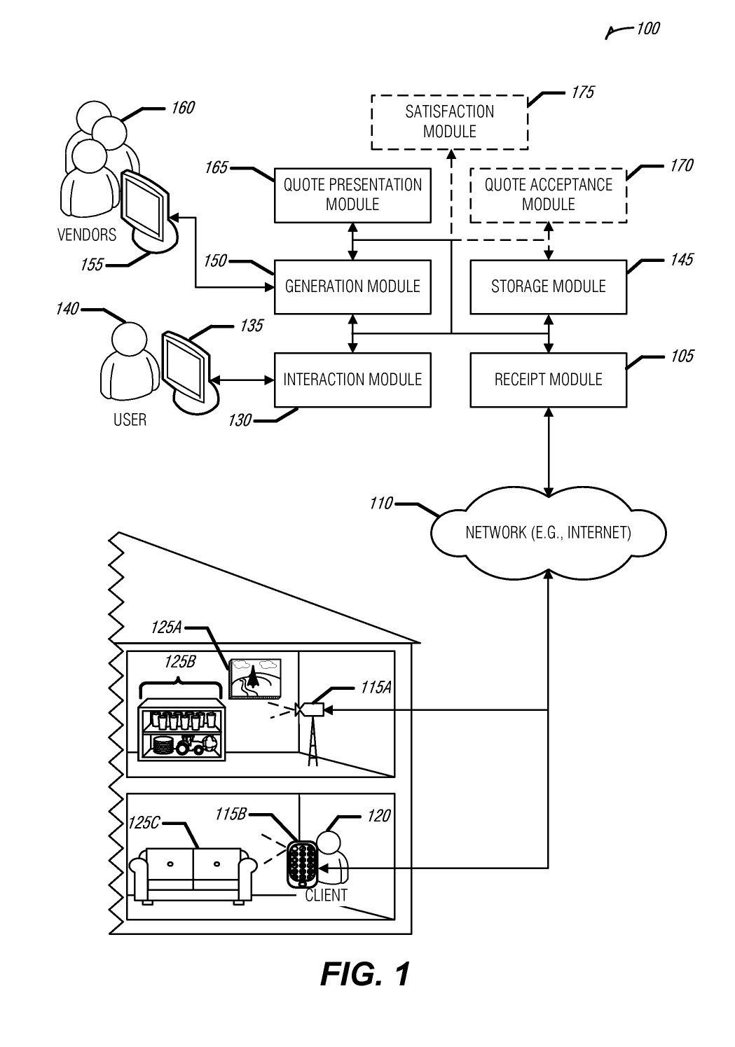

FIG. 1 illustrates an example of a system 100 for telepresence assisted item transport facilitation. The system 100 can include a receipt module 105, an interaction module 130, a storage module 145, a generation module 150, and a quote presentation module 165. In an example, the system 100 can include a quote acceptance module 170. In an example, the system 100 can include a satisfaction module 175.

The receipt module 105 can be arranged to receive telepresence data about a physical space where the physical space includes a plurality of transport items 125 for a client 120. As illustrated, transport items 125 can be anything that the client 120 wants to engage a transportation vendor 160 to move. Example transport items 125 can include large pieces (such as furniture 125C, safes, appliances, etc.), small pieces (e.g., shelf contents 125B, silverware, tools, clothes, toys, etc.), and special pieces (e.g., art 125A, collectables, fragile items, etc.), among others.

In an example, the telepresence data can be live. As used herein, and in common parlance, live (e.g., real-time) telepresence data is telepresence data where the delay between capture and observance by a remote party is small enough that the remote party perceives remote events contemporaneously with the occurrence of those events.

In an example, the telepresence data can be pre-recorded (e.g., such that the remote party observing the telepresence data does not perceive the remote events contemporaneously with the occurrence of those events). In an example (e.g., with pre-recorded telepresence data), the receipt module 105 can be arranged to provide instructions to the client 120. The instruction can include direction on how to produce the telepresence data. For example, the instructions can include a tutorial (e.g., written, video, interactive application) illustrating, for example, the angles to video record transport items 125, locations (e.g., in cupboards, garage, attic, etc.) to consider when searching for transport items 125, among other things. In an example, the instructions can be arranged to progress automatically. For example, the capture device 115B can include a capture module arranged to superimpose an orientation or perspective guide (e.g., a semi-transparent model of a transport item 125, guidelines, etc.) on a view screen of the capture device 115B camera and re-orient the guide to a second perspective of, or indicate that the capture is sufficient for, the transport item 125.

In an example, the telepresence data can include video of the physical space. In an example, the video is live. In an example, the telepresence data can include audio of the physical space. In an example, the telepresence data can include volumetric data of the physical space. For example, a range-finder can be arranged to provide distance from the capture device 115 information to surfaces or items in the physical space. In an example, the telepresence data can include tactile data. For example, a robot can measure resistance when handling transport items 125 (e.g., the perceived weight of a book that the robot picks up, the texture of a wooden book-shelf, etc.) and include the measurements in the telepresence data. Tactile data can also include a scale to include weight measurements in the telepresence data. In an example, the telepresence data can include logistical data about the physical space. Example logistical data can include ingress or egress points (e.g., doors, windows, attic portals, etc.), internal elevation access (e.g., stairs, elevators, etc.), internal passages (e.g., hallways, tunnels, ramps, etc.), external access (e.g., directions to the physical space, driveways, parking, secured gates, security codes, etc.). For example, a global positioning system (GPS) unit on a smartphone capture device 115B can provide the coordinates of transport items 125 as they are, for example, video recorded for the evaluation. Further, a volumetric sensor on the capture device 115B can provide dimensions of passages or ingress/egress points corresponding to coordinates as the client 120 moves from room to room.

In an example, the telepresence data can be captured by the client 120 manipulating a capture device 115 (e.g., tablet 115B, smart phone, video camera, etc.). In an example, the telepresence data can be captured by remote-controlled capture device 115A (e.g., robot, sensor platform, etc.). The capture device 115 can be arranged to transmit the telepresence data to the receipt module 105 via, for example, a network 110. In an example, the capture device 115 can be arranged to record the telepresence data on a machine-readable medium. In an example, the machine-readable medium can be transported to (e.g., by mail, courier, etc.), and subsequently read by, the receipt module 105 to receive the telepresence data.

In an example, to receive the telepresence data, the receipt module 105 can be arranged to provide a scheduler to the client 120 and receive an appointment to capture the telepresence data from the client 120. For example, where the client 120 manipulates the capture device 115B and the telepresence data is live, the scheduler can be arranged to provide a user 140 (e.g., evaluator, move captain, etc.) a schedule of available times from which the client 120 can choose.

The interaction module 130 can be arranged to provide an interaction interface 135 to accept user interaction commands. For example, in the case of recorded video, the interaction interface 135 can include video manipulation commands such as play, stop, pause, rewind, fast-forward, zoom in, resolution adjustments, color adjustments, effects (e.g., increase sharpness), among others. The interaction module 130 can also be arranged to interact with the telepresence data according to the user interaction. For example, the interaction module 130 can fast-forward video in response to receiving a fast-forward command via the interaction interface 135.

In an example, the interaction module 130 can be arranged to manipulate the telepresence data without user 140 intervention. For example, the interaction module 130 can be arranged to determine and outline shapes detected in video of the physical space to facilitate user 140 use of the telepresence data to create an evaluation. In an example, the interaction module 130 can be arranged to count transport items 125 based on analysis of the interaction data (e.g., using computer-vision object detection methods). In an example, the interaction module 130 can be arranged to automatically assess volumetric data of identified transport items 125. For example, given known optical properties of a particular video capture device 115B, and a range-finder to determine a distance between the capture device 115B and the transport item 125C, the interaction module 130 can determine the dimensions of the transport item 125C. In an example, the interaction module 130 can be arranged to use a visual cue (e.g., pattern of known dimensions) in the telepresence data to facilitate automatically assessing the volumetric data.

In an example, to interact with the telepresence data, the interaction module 130 can be arranged to provide direction to modify a current video capture perspective. For example, in live video capture by the client 120, the interaction module 130 can be arranged to communicate with the client 120 (e.g., via the capture device 115B). In an example, the interaction module 130 can be arranged to communicate voice data (e.g., originating from the user 140) to the physical space (e.g., a speaker in the capture device 115B). In an example, the direction can include commands to the remote-controlled capture device 115A. Such commands can include sensor orientation, motion, transport item 125 manipulation (e.g., lifting, moving, etc.), among other things.

The storage module 145 can be arranged to store a normalized evaluation for the plurality of transport items 125 based on the interacted telepresence data. In an example, the storage module 145 can be arranged to provide an interface with fields for the normalized evaluation and accept the user's 140 input to complete the fields based on a viewing of the telepresence data. In an example, the storage module 145 can be arranged to interact with the telepresence data directly, or via another module (e.g., the interaction module 130), to automatically provide portions of the normalized evaluation from the telepresence data. In an example, the storage module 145 can be arranged to accept, using an evaluation management interface, a modification to the normalized evaluation from the client 120. The storage module 145 can be arranged to update the normalized evaluation with the modification. For example, after the user 140 facilitates the creation of the normalized evaluation, the client 120 can access the normalized evaluation from the evaluation management interface. The client 120 may realize that an evaluated (e.g., inventoried) transport item 125A is promised to his brother and will not need to be transported. The client 120 can remove the transport item 125A from the normalized evaluation using the evaluation management interface.

The generation module 150 can be arranged to generate, using the normalized evaluation, a set of transport quotes for members of a set of transportation vendors 160 for the plurality of transport items 125. Although the plural forms of “members” and “quotes” are used to refer to these sets, the sets can also comprise zero members or a single member. Also, transport quotes are quotes (e.g., prices) to perform transport of the plurality of transport items 125. In an example, the set of transportation quotes includes a plurality of transportation quotes. In an example, the set of transportation quotes includes a single transportation quote.

In an example, to generate the set of transportation quotes, the generation module 150 can be arranged to apply one or more portions of a fee schedule provided by one or more transportation vendors 160. Thus, given a normalized evaluation, the fee schedule can be used to provide a quote on behalf of a transportation vendor 160 without direct interaction with the transportation vendor 160. In an example, the feed schedule can be, or can include, a tariff used (e.g., published) by a transportation vendor 160 (e.g., a moving company).

In an example, to generate the set of transportation quotes, the generation module 150 can be arranged to solicit, using the normalized evaluation, transportation quotes from members of the set of transportation vendors 160. For example, the generation module 150 can be arranged to send an electronic communication (e.g., email) with the normalized evaluation attached. In an example, the generation module 150 can be arranged to provide an alert (e.g., email message, text message, call, etc.) to a transportation vendor 160 of a new normalized evaluation. The transportation vendor 160 can then log-on to the vendor user interface 155 to view the normalized evaluation. In an example, the generation module 150 can be arranged to provide client information to members of the set of transportation vendors 160. In an example, the generation module 150 (or, for example, the receipt module 105) can be arranged to provide a user interface 155 to capture the client information. Client information can include one or more of, an address of the physical location, a destination address, specific instructions (e.g., time of day for move, removal of shoes, key location, special care items, etc.). In an example, the client information can include a logistical characteristic of the physical space. Example logistical characteristics can include ingress or egress points (e.g., doors, windows, attic portals, etc.), internal elevation access (e.g., stairs, elevators, etc.), internal passages (e.g., hallways, tunnels, ramps, etc.), external access (e.g., directions to the physical space, driveways, parking, secured gates, security codes, etc.).

In an example, the generation module 150 can be arranged to receive (e.g., via the vendor user interface 155) the transportation quotes in response to the solicitation. In an example, the generation module 150 can be arranged to provide the vendor user interface 155 to capture transport quote information from a member of the set of transportation vendors 160. For example, the transportation vendors 160 can use the vendor user interface 155 to provide respective quotes for the transport items 125 given the client information (e.g., distance between the physical location and the destination). The generation module 150 can be arranged to include the transportation quotes in the set of transportation quotes. The solicited transportation quotes can be all, some, or none of the members of the set of transportation quotes. In an example, the set of transportation quotes includes at least one solicited transportation quote and one quote determined by a fee schedule.

In an example, the generation module 150 can be arranged to supplement members of the set of transportation quotes. Supplements can include the correction of errors determined by a third-party source, add-on services (e.g., insurance), discounts, surcharges, etc.

The quote presentation module 165 can be arranged to present the set of transportation quotes to the client 120. For example, a client user interface can provide a listing of the available quotes. In an example, the client user interface can include supplemental information about members of the set of transportation vendors 160, such as satisfaction ratings, bonding status, years in business, better business bureau complaints, awards, etc. In an example, the quote presentation module 165 can be arranged to communicate using electronic messaging (e.g., email), telephone, or printing and mailing materials, to present the set of transportation quotes to the client 120.

The quote acceptance module 170 can be arranged to receive client 120 acceptance of a quote in the set of transportation quotes presented to the client 120. The quote acceptance module 170 can be arranged to notify the respective transportation vendor 160 (e.g., the one responsible for the accepted quote) of the acceptance. Thus, the respective transportation vendor 160 can begin preparations to carry out transportation of the transport items 125.

In an example, the quote acceptance module 170 can be arranged to receive client payment information. The client payment information can include credit card information, alternative electronic payment information, or cash. In an example the client payment information can include a credit check and an extension of credit to the client 120. In an example, to notify the respective transportation vendor 160, the quote acceptance module 170 can be arranged to provide payment information to the respective transportation vendor 160. The payment information, such as credit card information, is sufficient for the respective transportation vendor 160 to receive payment. In an example, the payment information can include an invoice (e.g., billing information or billing instructions). In an example, the payment information is the client payment information. In an example, the payment information is not the client payment information. In an example, the payment information is payment itself (e.g., cash or check).

The satisfaction module 175 can be arranged to receive a notification that a concluding transport event has occurred. Example concluding transport events can include: the transport was successfully completed, the client 120 fired the transportation vendor 160, the transportation vendor 160 could not complete the transport, of other situation such that the immediate relationship between the client 120 and the transportation vendor 160 has ceased. The notification can include a message, entry into a user interface 155, or other machine-readable form of communication. In an example, the notification can indicate the specific type of concluding event. In an example, the notification can include the parties (e.g., specific client 120 and transportation vendor 160) involved with one or more of the transport or the concluding event.

The satisfaction module 175 can be arranged to solicit feedback, via a user interface 155, from at least one party about the transport of the plurality of transport items 125. In an example, the solicitation can be in response to receiving the notification of the concluding event. In an example, the satisfaction module 175 can store the feedback. In an example, the stored feedback can be used (e.g., by the quote generation module 150 or the quote presentation module 165) to provide additional information to the parties. Such information can, for example, help the client 120 avoid a poor transportation vendor 160 even when their quote is the lowest. Also, transportation vendors 160 can assess additional costs (or discounts) for individual clients 120 based on the perceived difficulty of working with those clients 120 based on the additional information.

The system 100 addresses the problems of cost and convenience inherent with client 120 provided evaluations and on-site evaluations. Not only are client concerns mitigated over these techniques, but transportation vendors 160 can also avoid the additional cost and burden of employing enough skilled evaluators or having to risk basing quotes on poor evaluations. Moreover, additional services, such as credit extension, insurance, inventory management, can also be provided use the system 100. Thus, item transport facilitation is assisted using telepresence data.

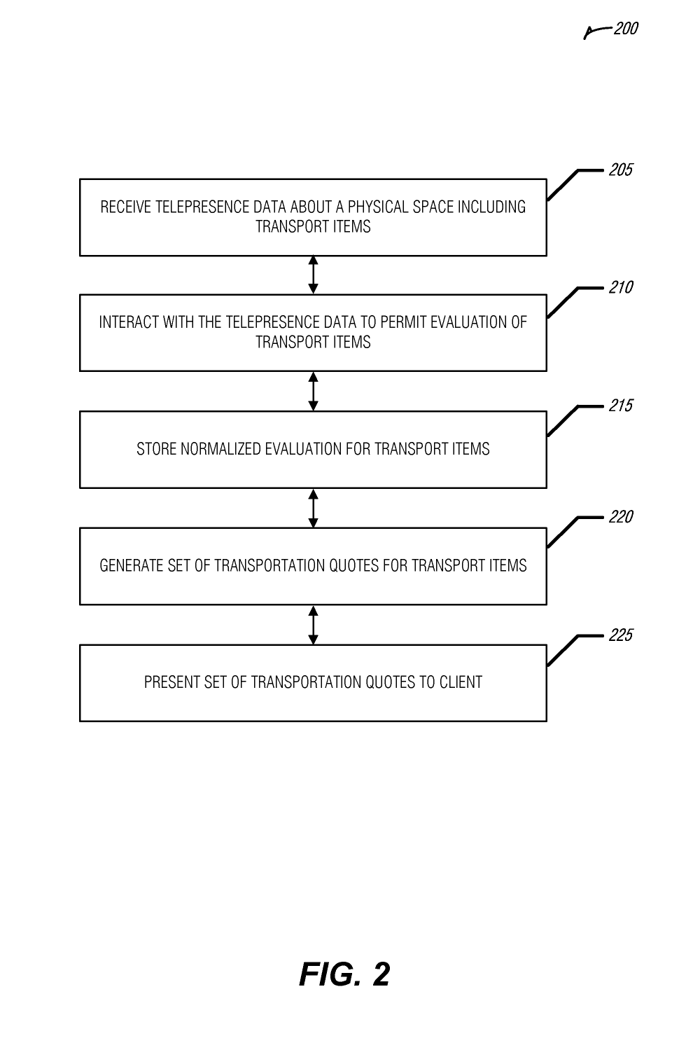

FIGS. 2-7 discuss examples of methods, or sub-methods, for telepresence assisted item transport facilitation. One or more components discussed above with respect to FIG. 1 can be used to implement one or more operations of these methods. All operations illustrated in FIGS. 2-7 are implemented using one or more hardware (e.g., computing) components. Further, the specific examples provided above further inform the various operations discussed below.

FIG. 2 illustrates an example of a method 200 for telepresence assisted item transport facilitation.

At operation 205, telepresence data about a physical space can be received. The physical space can include a plurality of transport items for a client. In an example, the telepresence data can include video of the physical space. In an example the video is live. In an example, the telepresence data can be pre-recorded. In an example, receiving the telepresence data can include providing instructions to the client. In an example, the instructions are provided automatically (e.g., without user intervention). The instructions provide direction on how to produce the telepresence data.

At operation 210, the telepresence data can be interacted with to permit evaluation of the plurality of transport items. In an example (e.g., of live video telepresence data), the interaction can include providing direction (e.g., to the client) to modify a current video capture perspective (e.g., from a different distance, angle, for a longer duration, to move on to another transport item, etc.). In an example, providing direction includes communicating voice data to the physical space.

At operation 215, a normalized evaluation can be stored. The normalized evaluation can be based on the interaction with the telepresence data referred to at operation 210.

At operation 220, a set of transportation quotes can be generated using the normalized evaluation. The set of transportation quotes can be generated for members of a set of transportation vendors and for the plurality of transport items. The transportation quotes can be quotes to perform transport (e.g., moving) of the plurality of transport items.

At operation 225, the set of transportation quotes can be presented to the client.

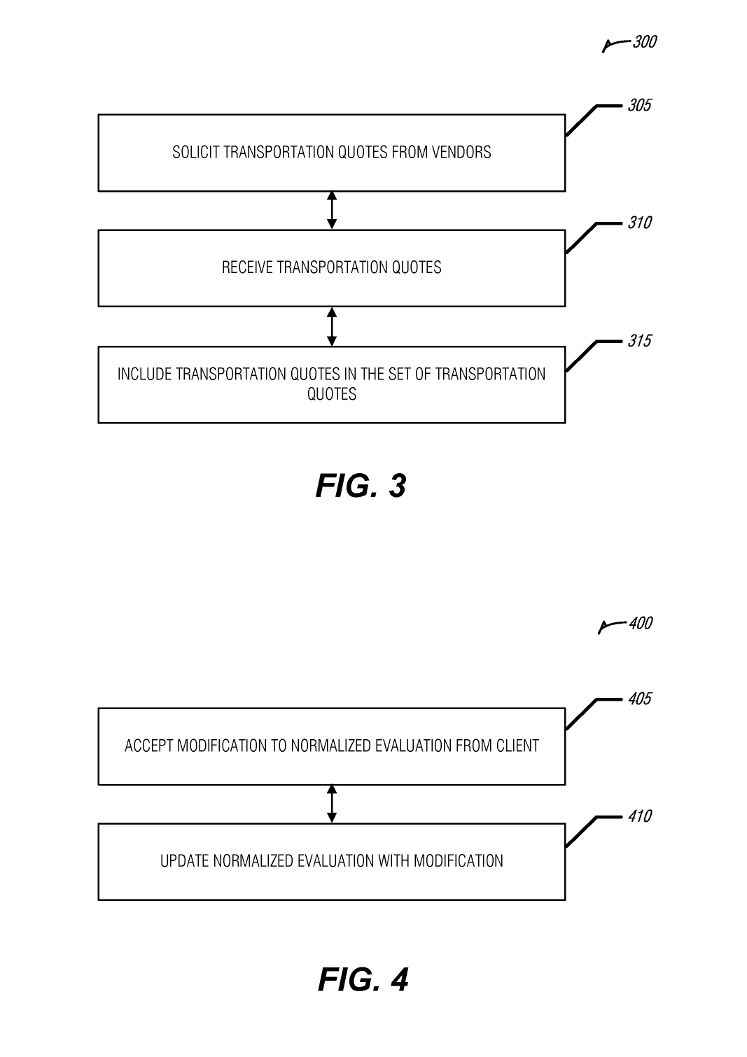

FIG. 3 illustrates an example of a method 300 for generating transportation quotes. In an example, the method 300 can be included in an operation like 220 referenced above.

At operation 305, transportation quotes can be solicited from members of the set of transportation vendors using a normalized evaluation. In an example, the soliciting can include providing a user interface to capture client information from the client and providing the client information to members of the set of transportation vendors.

At operation 310, the transportation quotes can be received in response to the solicitation. In an example, the receiving of the transportation quotes can include providing a vendor user interface to capture transport quote information from a member of the set of transportation vendors.

At operation 315, the transportation quotes can be included in the set of transportation quotes. As discussed with respect to FIG. 1, the solicited quotes can be combined in any manner with quotes generated using existing information, such as previously provided fee schedule from transportation vendors.

FIG. 4 illustrates an example of a method 400 for updating the stored normalized evaluation. In an example, the method 400 can be included in an operation like 215 referenced above.

At operation 405, a modification to a stored normalized evaluation can be accepted from a client. In an example, the modification is accepted using an evaluation management interface.

At operation 410, the normalized evaluation can be updated with the modification received at operation 405.

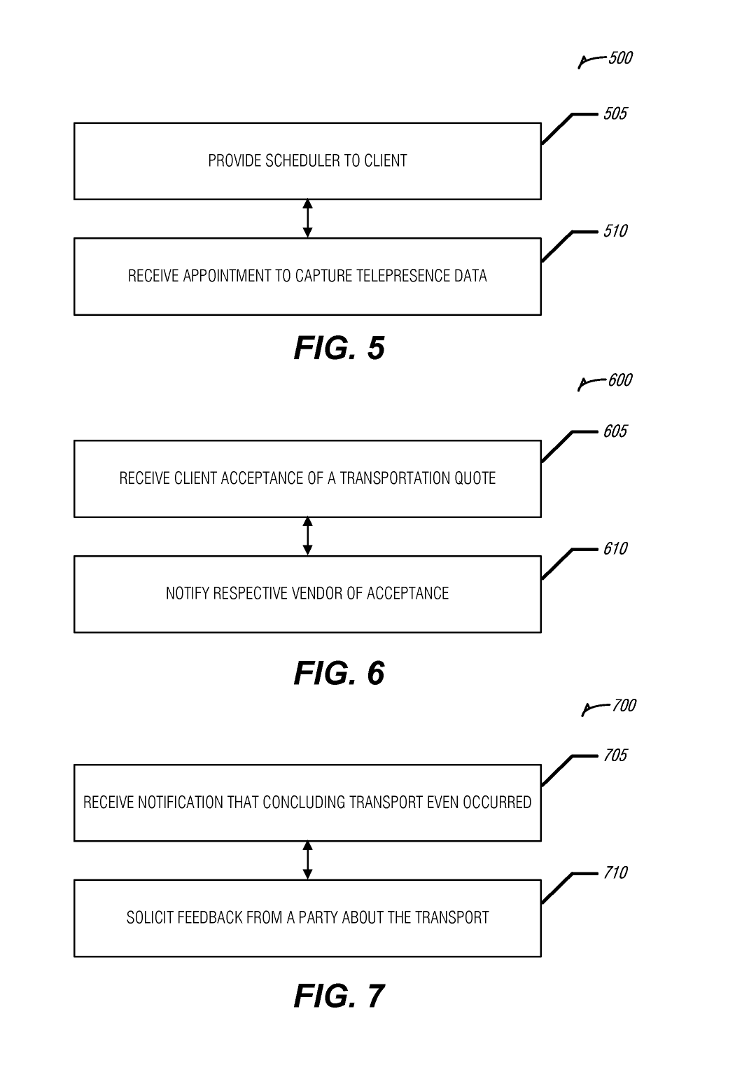

FIG. 5 illustrates an example of a method 500 for scheduling telepresence data capture. In an example, the method 500 can be included in an operation like 205 referenced above.

At operation 505, a scheduler can be provided to the client.

At operation 510, an appointment to capture the telepresence data can be received from the client.

FIG. 6 illustrates an example of a method 600 for client quote acceptance.

At operation 605, client acceptance of a transportation quote in the set of transportation quotes previously presented to the client can be received. In an example, receiving client acceptance of the transportation quote includes receiving client payment information.

At operation 610, the respective (i.e., to the transportation quote accepted by the client in operation 605) transportation vendor can be notified of the acceptance. In an example, notifying the respective transportation vendor can include providing payment information to the respective transportation vendor. In an example, the payment information is the client payment information received in operation 605.

FIG. 7 illustrates an example of a method 700 for incorporating feedback of item transport.

At operation 705, a notification that a concluding transport event has occurred can be received.

At operation 710, feedback can be solicited from at least one party about the transport of the plurality of transport items. The feedback can be solicited in response to receiving the notification of operation 705. In an example, the feedback can be solicited via a user interface.

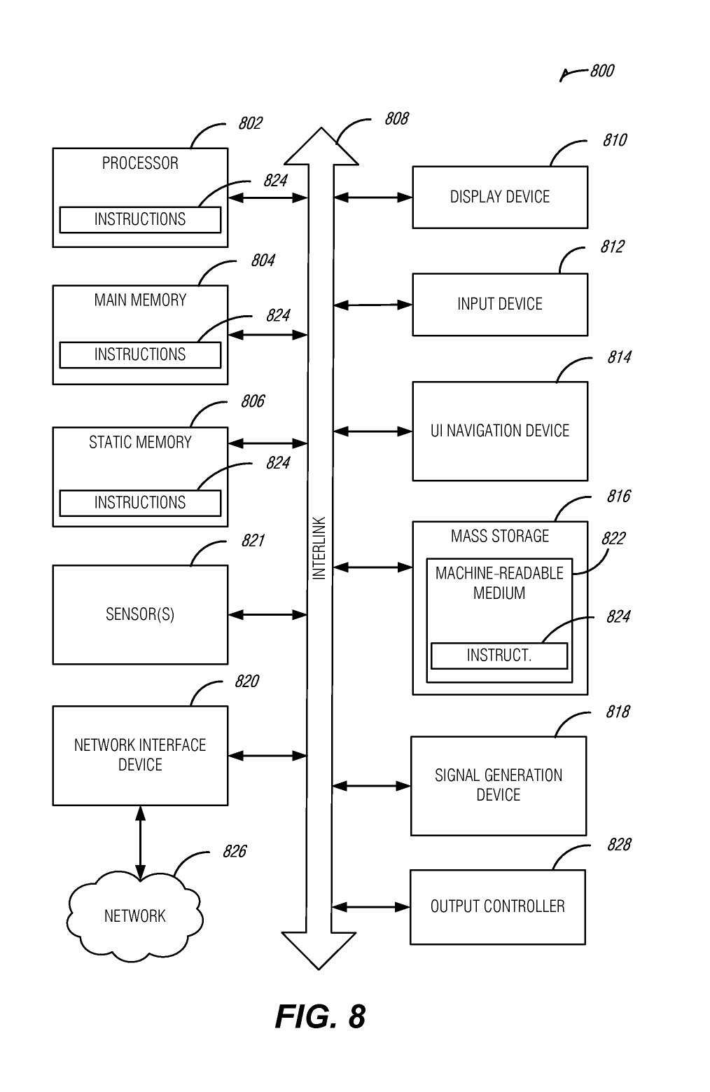

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in a peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Additional Notes & Examples

Example 1 can include subject matter (such as a device, apparatus, or system for telepresence assisted item transport facilitation) comprising a receipt module arranged to receive telepresence data about a physical space—the physical space including a plurality of transport items for a client, an interaction module arranged to provide an interaction interface to accept user interaction commands, and interact with the telepresence data according to the user interaction commands to permit evaluation of the plurality of transport items, a storage module arranged to store a normalized evaluation for the plurality of transport items based on the interacted telepresence data, a generation module arranged to generate, using the normalized evaluation—a set of transportation quotes for members of a set of transportation vendors for the plurality of transport items—the transport quotes being quotes to perform transport of the plurality of transport items, and a quote presentation module arranged to present the set of transportation quotes to the client.

In Example 2, the subject matter of Example 1 can optionally include, wherein to generate the set of transportation quotes includes the generation module arranged to solicit, using the normalized evaluation—transportation quotes from members of the set of transportation vendors, and receive the transportation quotes in response to the solicitation, and include the transportation quotes in the set of transportation quotes.

In Example 3, the subject matter of Example 2 can optionally include, wherein to solicit the transportation quotes includes the generation module arranged to provide client information to the members of the set of transportation vendors, and provide a user interface to capture the client information from the client.

In Example 4, the subject matter of one or more of Examples 2-3 can optionally include, wherein to receive the transportation quotes includes the generation module arranged to provide a vendor user interface to capture transport quote information from a member of the set of transportation vendors.

In Example 5, the subject matter of one or more of Examples 1-4 can optionally include, wherein to store the normalized evaluation includes the storage module arranged to accept—using an evaluation management interface—a modification to the normalized evaluation from the client, and update the normalized evaluation with the modification.

In Example 6, the subject matter of one or more of Examples 1-5 can optionally include, wherein the telepresence data includes video of the physical space.

In Example 7, the subject matter of Example 6 can optionally include, wherein the video is live, and wherein interacting with the telepresence data includes the interaction module arranged to provide direction to modify a current video capture perspective.

In Example 8, the subject matter of Example 7 can optionally include, wherein to provide direction includes the interaction module arranged to communicate voice data to the physical space.

In Example 9, the subject matter of one or more of Examples 7-8 can optionally include, wherein to receive telepresence data includes the receipt module arranged to provide a scheduler to the client, and receive an appointment to capture the telepresence data from the client.

In Example 10, the subject matter of one or more of Examples 6-9 can optionally include, wherein the telepresence data is pre-recorded, and wherein to receive the telepresence data includes the receipt module arranged to provide instructions to the client, the instructions including direction on how to produce the telepresence data.

In Example 11, the subject matter of one or more of Examples 1-10 can optionally include a quote acceptance module arranged to receive client acceptance of a quote in the set of transportation quotes presented to the client, and notify the respective transportation vendor of the acceptance.

In Example 12, the subject matter of Example 11 can optionally include, wherein to receive client acceptance of the quote includes the quote acceptance module arranged to receive client payment information, and wherein to notify the respective transportation vendor includes the quote acceptance module arranged to provide payment information to the respective transportation vendor.

In Example 13, the subject matter of one or more of Examples 1-12 can optionally include a satisfaction module arranged to receive a notification that a concluding transport event has occurred, and solicit feedback—via a provided user interface—from at least one party about the transport of the plurality of transport items in response to receiving the notification.

Example 14 can optionally include, or may optionally be combined with the subject matter of any one of Examples 1-13 to include, subject matter (such as a method, means for performing acts, or machine readable medium including instructions that, when performed by a machine cause the machine to performs acts) comprising receiving telepresence data about a physical space—the physical space including a plurality of transport items for a client, interacting with the telepresence data to permit evaluation of the plurality of transport items, storing a normalized evaluation for the plurality of transport items based on the interaction with the telepresence presence data, generating, using the normalized evaluation—a set of transportation quotes for members of a set of transportation vendors for the plurality of transport items—the transportation quotes being quotes to perform transport of the plurality of transport items, and presenting the set of transportation quotes to the client.

In Example 15, the subject matter of Example 14 can optionally include, wherein generating transportation quotes includes soliciting—using the normalized evaluation—transportation quotes from members of the set of transportation vendors, and receiving the transportation quotes in response to the soliciting, and including the transportation quotes in the set of transportation quotes.

In Example 16, the subject matter of Example 15 can optionally include, wherein soliciting the set of transportation quotes includes providing client information to the members of the set of transportation vendors—wherein the operations comprise providing a user interface to capture the client information from the client.

In Example 17, the subject matter of one or more of Examples 15-16 can optionally include, wherein receiving the transportation quotes includes providing a vendor user interface to capture transport quote information from a member of the set of transportation vendors.

In Example 18, the subject matter of one or more of Examples 14-16 can optionally include, wherein storing the normalized evaluation includes accepting—using an evaluation management interface—a modification to the normalized evaluation from the client, and updating the normalized evaluation with the modification.

In Example 19, the subject matter of one or more of Examples 14-18 can optionally include, wherein the telepresence data includes video of the physical space.

In Example 20, the subject matter of Example 19 can optionally include, wherein the video is live, and wherein interacting with the telepresence data includes providing direction to modify a current video capture perspective.

In Example 21, the subject matter of Example 20 can optionally include, wherein providing direction includes communicating voice data to the physical space.

In Example 22, the subject matter of one or more of Examples 20-21 can optionally include, wherein receiving telepresence data includes providing a scheduler to the client, and receiving an appointment to capture the telepresence data from the client.

In Example 23, the subject matter of one or more of Examples 19-22 can optionally include, wherein the telepresence data is pre-recorded, and wherein receiving the telepresence data includes providing instructions to the client, the instructions providing direction on how to produce the telepresence data.

In Example 24, the subject matter of one or more of Examples 14-23 can optionally include, wherein the operations comprise receiving client acceptance of a transportation quote in the set of transportation quotes presented to the client and notifying the respective transportation vendor of the acceptance.

In Example 25, the subject matter of Example 24 can optionally include, wherein receiving client acceptance of the quote includes receiving client payment information, and wherein notifying the respective transportation vendor includes providing payment information to the respective transportation vendor.

In Example 26, the subject matter of one or more of Examples 14-25 can optionally include, wherein the operations comprise receiving a notification that a concluding transport event has occurred, and soliciting feedback, via a provided user interface, from at least one party about the transport of the plurality of transport items in response to receiving the notification.

The above detailed description includes references to the accompanying drawings, which form a part of the detailed description. The drawings show, by way of illustration, specific embodiments in that may be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system comprising:
a receipt module arranged to receive telepresence data about a physical space, the physical space including a plurality of transport items for a client;
an interaction module arranged to:
provide an interaction interface to accept user interaction commands; and
interact with the telepresence data according to the user interaction commands to permit evaluation of the plurality of transport items;
a storage module arranged to store a normalized evaluation for the plurality of transport items based on the interacted telepresence data;
a generation module arranged to generate, using the normalized evaluation, a set of transportation quotes for members of a set of transportation vendors for the plurality of transport items, the transport quotes being quotes to perform transport of the plurality of transport items; and
a quote presentation module arranged to present the set of transportation quotes to the client.

2. The system of claim 1, wherein to generate the set of transportation quotes includes the generation module arranged to:
solicit, using the normalized evaluation, transportation quotes from members of the set of transportation vendors;
receive the transportation quotes in response to the solicitation; and
include the transportation quotes in the set of transportation quotes.

3. The system of claim 2, wherein to solicit the transportation quotes includes the generation module arranged to:
provide a user interface to capture client information from the client; and
provide the client information to the members of the set of transportation vendors.

4. The system of claim 2, wherein to receive the transportation quotes includes the generation module arranged to provide a vendor user interface to capture transport quote information from a member of the set of transportation vendors.

5. The system of claim 1, wherein to store the normalized evaluation includes the storage module arranged to:
accept, using an evaluation management interface, a modification to the normalized evaluation from the client; and
update the normalized evaluation with the modification.

6. The system of claim 1, wherein the telepresence data includes video of the physical space, wherein the video is live, and wherein interacting with the telepresence data includes the interaction module arranged to provide direction to modify a current video capture perspective.

7. The system of claim 6, wherein to receive telepresence data includes the receipt module arranged to:
provide a scheduler to the client; and
receive an appointment to capture the telepresence data from the client.

8. The system of claim 1 comprising a quote acceptance module arranged to:
receive client acceptance of a quote in the set of transportation quotes presented to the client; and
notify the respective transportation vendor of the acceptance.

9. The system of claim 8, wherein to receive client acceptance of the transportation quote includes the quote acceptance module arranged to receive client payment information, and wherein to notify the respective transportation vendor includes the quote acceptance module arranged to provide payment information to the respective transportation vendor.

10. The system of claim 1 comprising a satisfaction module arranged to:
receive a notification that a concluding transport event has occurred; and
solicit feedback, via a provided user interface, from at least one party about the transport of the plurality of transport items in response to receiving the notification.

11. A massed machine-readable medium (MMRM) including instructions that, when executed by a machine, cause the machine to perform operations comprising:
receiving telepresence data about a physical space, the physical space including a plurality of transport items for a client;
interacting with the telepresence data to permit evaluation of the plurality of transport items;
storing a normalized evaluation for the plurality of transport items based on the interaction with the telepresence presence data;
generating, using the normalized evaluation, a set of transportation quotes for members of a set of transportation vendors for the plurality of transport items, the transportation quotes being quotes to perform transport of the plurality of transport items; and
presenting the set of transportation quotes to the client.

12. The MMRM of claim 11, wherein generating transportation quotes includes:
soliciting, using the normalized evaluation, transportation quotes from members of the set of transportation vendors;
receiving the transportation quotes in response to the soliciting; and
including the transportation quotes in the set of transportation quotes.

13. The MMRM of claim 12, wherein soliciting the set of transportation quotes includes providing client information to the members of the set of transportation vendors, wherein the operations comprise providing a user interface to capture the client information from the client.

14. The MMRM of claim 12, wherein receiving the transportation quotes includes providing a vendor user interface to capture transport quote information from a member of the set of transportation vendors.

15. The MMRM of claim 11, wherein storing the normalized evaluation includes:
accepting, using an evaluation management interface, a modification to the normalized evaluation from the client; and
updating the normalized evaluation with the modification.

16. The MMRM of claim 11, wherein the telepresence data includes video of the physical space.

17. The MMRM of claim 16, wherein the video is live, and wherein interacting with the telepresence data includes providing direction to modify a current video capture perspective.

18. The MMRM of claim 17, wherein providing direction includes communicating voice data to the physical space.

19. The MMRM of claim 17, wherein receiving telepresence data includes:
providing a scheduler to the client; and
receiving an appointment to capture the telepresence data from the client.

20. The MMRM of claim 16, wherein the telepresence data is pre-recorded, and wherein receiving the telepresence data includes providing instructions to the client, the instructions providing direction on how to produce the telepresence data.

21. The MMRM of claim 11, wherein the operations comprise:
receiving client acceptance of a transportation quote in the set of transportation quotes presented to the client; and
notifying the respective transportation vendor of the acceptance.

22. The MMRM of claim 21, wherein receiving client acceptance of the transportation quote includes receiving client payment information, and wherein notifying the respective transportation vendor includes providing payment information to the respective transportation vendor.

23. The MMRM of claim 11, wherein the operations comprise:
receiving a notification that a concluding transport event has occurred; and
soliciting feedback, via a provided user interface, from at least one party about the transport of the plurality of transport items in response to receiving the notification.

24. A computer-processor-implemented method comprising:
receiving telepresence data about a physical space, the physical space including a plurality of transport items for a client;
interacting with the telepresence data to permit evaluation of the plurality of transport items;
storing a normalized evaluation for the plurality of transport items based on the interaction with the telepresence data;
generating, using the normalized evaluation, a set of transportation quotes for members of a set of transportation vendors for the plurality of transport items, the transportation quotes being quotes to perform transport of the plurality of transport items; and
presenting the set of transportation quotes to the client.

25. The method of claim 24, wherein generating transportation quotes includes:
soliciting, using the normalized evaluation, transportation quotes from members of the set of transportation vendors;
receiving the transportation quotes in response to the soliciting; and
including the transportation quotes in the set of transportation quotes.

26. The method of claim 24, wherein storing the normalized evaluation includes:
accepting, using an evaluation management interface, a modification to the normalized evaluation from the client; and
updating the normalized evaluation with the modification.

27. The method of claim 24, wherein the telepresence data includes video of the physical space, wherein the video is live, and wherein interacting with the telepresence data includes providing direction to modify a current video capture perspective.

28. The method of claim 24, wherein the telepresence data includes video of the physical space, wherein the telepresence data is pre-recorded, and wherein receiving the telepresence data includes providing instructions to the client, the instructions providing direction on how to produce the telepresence data.

29. The method of claim 24, comprising:
receiving client acceptance of a transportation quote in the set of transportation quotes presented to the client; and
notifying the respective transportation vendor of the acceptance.

30. The method of claim 24, comprising:
receiving a notification that a concluding transport event has occurred; and
soliciting feedback, via a provided user interface, from at least one party about the transport of the plurality of transport items in response to receiving the notification.
